(19) United States
(12) Patent Application Publication
(10) Pub. No.: US 2006/0245335 A1
(43) Pub. Date: Nov. 2, 2006

(54) Optical head and information recording/reproducing apparatus

(76) Inventors: Kazuhiro Nagata, Yokohama-shi (JP); Katsuo Iwata, Yokohama-shi (JP); Yuuichi Nakamura, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/410,123

(22) Filed: Apr. 25, 2006

(30) Foreign Application Priority Data
Apr. 27, 2005 (JP) 2005-129858

(51) Int. Cl. G11B 7/135

(52) U.S. Cl. 369/112.28

(57) ABSTRACT

To provide an optical head unit and an information recording/reproducing apparatus which are configured to provide a stable reproducing signal when reproducing information from a recording medium of a corresponding standard by selectively using laser beams with different wavelengths, a stable reproduce signal is obtained by one object lens when reproducing information from a recording medium of a standard defined according to each of three laser beams with different wavelengths, by arranging first to third light sources capable of outputting lights with different wavelengths, first and second wavelength selection films related to the arrangement of the light sources, and a polarization beam splitter in a predetermined order, and separating an output for power monitor by a polarization beam splitter.

### CROSS-REFERENCE TO RELATED APPLICATIONS

This application is based upon and claims the benefit of priority from Japanese Patent Application No. 2005-129858, filed Apr. 27, 2005, the entire contents of which are incorporated herein by reference.

### BACKGROUND

1. Field

One embodiment of the invention relates to an information recording/reproducing apparatus which records or reproduces information in/from an optical information recording medium or an optical disc, and an optical head incorporated in the information recording/reproducing apparatus.

2. Description of the Related Art

A long time has been passed since the commercialization of an optical disc capable of recording or reproducing information in a noncontact manner by using a laser beam, and an optical disc apparatus (an optical disc drive) which is capable of recording and reproducing information in/from an optical disc. Optical discs with several kinds of recording density called CD and DVD have become popular.

Recently, an ultra-high density optical disc HD (High Density) DVD (hereinafter abbreviated as HD DVD) using a laser beam with a blue or purple wavelength to record information to increase the recording density, has been put to practical use.

It is inefficient from the viewpoint of cost and installation place to prepare a different optical disc apparatus (a disk drive) for each of various types of optical disc. An optical disc apparatus is required to be capable of recording, reproducing and erasing information on/from optical discs of two or more standards.

A laser beam with a wavelength of 785 nm for example is used for recording, reproducing and erasing information on/from a CD standard optical disc that is already very popular. The wavelength of a laser beam used for a DVD standard disc is 655 nm, for example. The wavelength of a laser beam used for recording, reproducing and erasing information on/from a HD-DVD standard disc is 400 to 410 nm.

An optical disc apparatus includes a light transmitting system to radiate a laser beam with a fixed wavelength to a predetermined position on an optical disc (a recording medium), a light-receiving system to detect a laser beam reflected by an optical disc, a mechanism control (servo) system to control the operations of the light transmitting system and light-receiving system, and a signal processing system which supplies recording information and an erase signal to the light transmitting system, and reproduces recorded information from a signal detected by the light-receiving system.

The light transmitting system and light-receiving system include a semiconductor laser element (laser diode), and an object lens which condenses a laser beam from a laser diode on the recording surface of an optical disc and captures a laser beam reflected by an optical disc, which are formed as one unit called an optical head or optical pickup (head).

However, it increases the size and cost of an optical disc drive to prepare different optical heads for each wavelength of laser beam (optical disc standard) for recording or reproducing information in/from several standard optical discs.

In the above background, many proposals have been made to output laser beams with different wavelengths with a single optical head or optical pickup.

For example, Japanese Patent Application Publication (KOKAI) No. 2004-185781 proposes an optical pickup using a common optical axis for a red optical beam for DVD and a blue beam for high-density recording, in which a pair of beam expander lenses is provided before and after a dichroic prism, a spherical aberration generated in the blue beam is corrected, and both red and blue beams are made parallel.

However, the optical pickup of the above Publication merely use an optical axis common to a red optical beam for DVD and a blue beam for high-density recording, and does not unify three wavelength laser beams including a laser beam of 785 nm for a CD standard widely used today.

Further, even if a laser beam source for CD is provided at an optional position of the optical path in the optical pickup of the above Publication, it is not easy to obtain a reproducing signal from CD.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus in accordance with an embodiment of the invention;

FIG. 2 is an exemplary diagram showing an example of a diffraction element incorporated in an optical head (PHU) of the optical disc apparatus shown in FIG. 1;

FIG. 3A is a graph explaining an optical characteristic of the first optical coupling prism (32);

FIG. 3B is a graph explaining an optical characteristic of the polarization beam splitter (37);

FIG. 3C is a graph explaining an optical characteristic of the second optical coupling prism (33); and

FIGS. 4A and 4B are graphs each explaining an exemplary film characteristic inverting band (wavelength characteristic) of a wavelength selection film used for an optical head (PUH) of the optical disc apparatus shown in FIG. 2, according to an embodiment of the invention.

### DETAILED DESCRIPTION

Various embodiments according to the invention will be described hereinafter with reference to the accompanying drawings. In general, according to one embodiment of the invention, an optical head unit which is configured to provide a reproducing signal when reproducing information from a recording medium of a corresponding standard by selectively using laser beams with different wavelengths, a reproduce signal is obtained by one object lens when reproducing information from a recording medium of a standard defined according to each of three laser beams with different wavelengths, by arranging first to third light sources capable of outputting lights with different wavelengths, first and second wavelength selection films related to the arrangement of the light sources, and a polarization beam splitter in a predetermined order, and separating an output for power monitor by a polarization beam splitter.

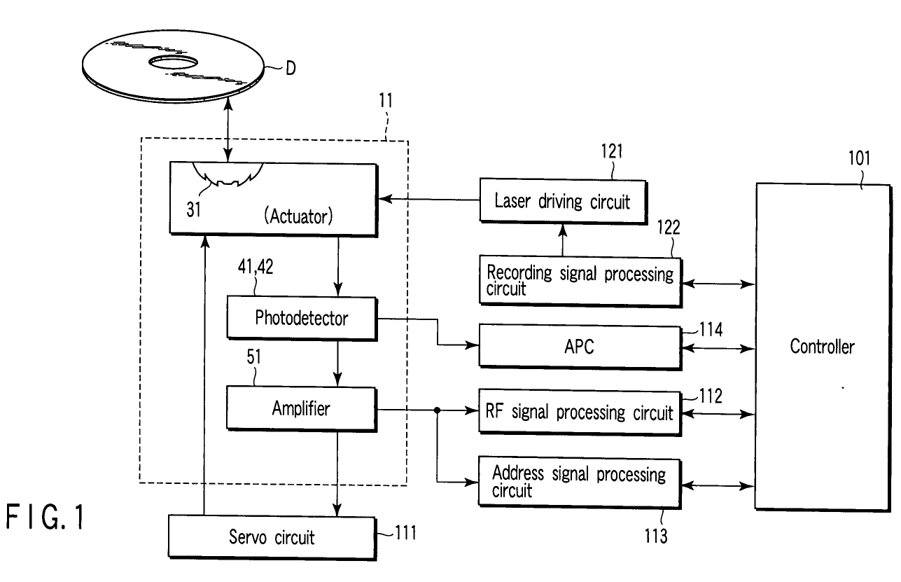

According to an embodiment, FIG. 1 shows an example of the configuration of an information recording/reproducing apparatus (an optical disc apparatus), to which the embodiments of the invention are applicable.

An optical disc apparatus 1 shown in FIG. 1 can record or reproducing information on/from an optical disc D, by condensing a laser beam of predetermined wavelength explained hereinafter from an optical pickup (PUH actuator) 11 on an information recording layer of an optical disc D corresponding to an optional kind (standard) explained hereafter. The optical disc D is a disc of CD or DVD standard, or a HD (high density) DVD disc with the recording density increased to higher than the CD and DVD standards.

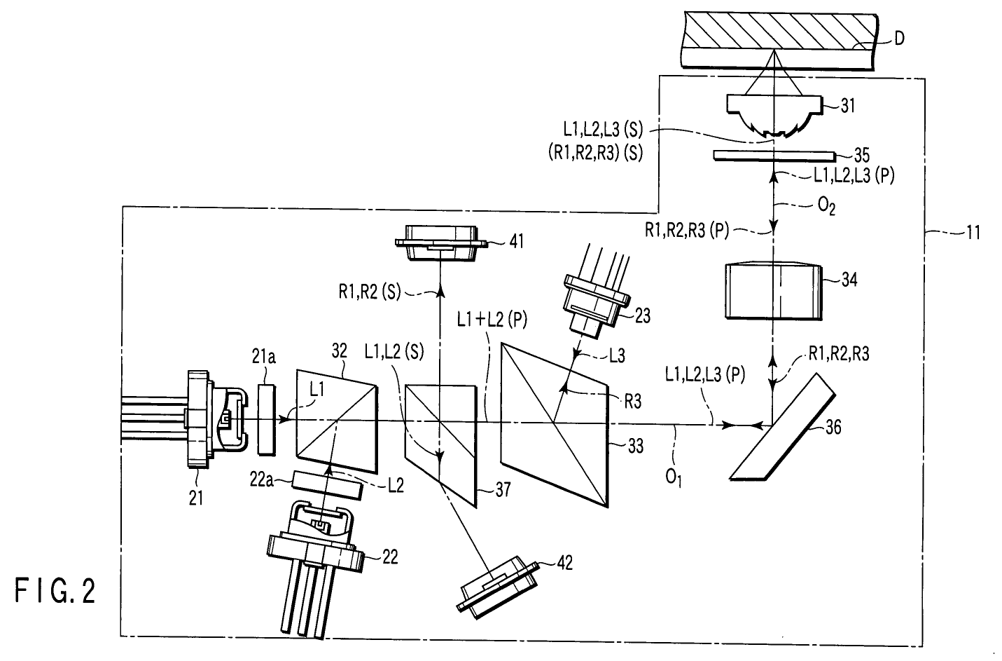

The PUH 11 can output any one of optical beams with first wavelength (405 nm), second wavelength (655 nm) and third wavelength (785 nm), according to the kind of a mounted optical disc D, as explained in a later paragraph with reference to FIG. 2. The PUH 11 also detects a reflected laser beam reflected on a not-shown information-recording surface of the optical disk D, and outputs an output signal usable for reproducing information already recorded.

Specifically, the reflected laser beam reflected by the optical disc D is detected by a photodetector 41 of the PUH 11 and a photodetector 42 for APC, and converted to an output signal with the size changed corresponding to the intensity of the light. The output signal of the photodetector 41 is amplified to a predetermined level by an amplifier 51, and output to a pickup servo circuit 111, RF signal processing circuit (output signal processing circuit) 112 and address signal processing circuit 113 which are connected to a controller (main control unit) 101. The output of the photodetector 42 for APC is supplied to the controller 101 through an APC (Auto Power Control) circuit 114, and used to control the largeness of a driving current output from a laser driving circuit 121 to a laser element, as explained in detail in a later paragraph with reference to FIG. 2.

The servo circuit 111 generates a focus servo signal (to control the difference in the distance between a recording layer of the optical disc D and an object lens, with respect to the focal position of an object lens) for an object lens of the PUH 11, and a tracking servo signal (to control the position of an object lens in the direction of crossing the track of the optical disc D), as explained in detail in a later paragraph with reference to FIG. 2. These signals are output to a not-shown focus actuator and tracking actuator, respectively.

The RF signal processing circuit 112 takes out user data and management information from a signal detected and reproduced by a photodetector, and to output the controller 101. The address signal processing circuit 113 takes out address information, that is, information indicating a track or sector of the optical disc D opposed now to the object lens of the PUH 11. The taken-out information is output to the controller 101.

The controller 101 controls the position of the PUH 11 to read data such as user data at a desired position, or to record user data and management information at a desired position, based on the address information.

The controller 101 instructs an optical intensity of a laser beam to be output from a laser element (LD) when recording or reproducing information on/from the optical disc D. According to the instruction of the controller 101, the data recorded at an address of a desired position (or sector) can be erased.

When recording information on the optical disc D, (under the control of the controller 101) a recording signal processing circuit 122 supplies the laser driving circuit (LDD) 121 with a recording data, or a recording signal modulated to a recording waveform signal suitable for recording on the optical disc D. Therefore, the laser element of the PUH 11 emits a laser beam with the intensity changed according to recording information, corresponding to a laser driving signal output from the LDD (laser driving circuit) 121. Information is recorded on the optical disc D by this.

FIG. 2 shows an example of the configuration of PUH (an optical pickup, or an optical head) of the optical disc apparatus shown in FIG. 1.

The PUH 11 includes a first light source 21 that is a semiconductor laser element, for example. The wavelength of an optical beam emitted from the first light source 21 is 400 to 410 nm, preferably 405 nm. The PUH 11 also includes a second light source 22 that is a semiconductor laser element, for example. The wavelength of an optical beam emitted from the second light source 22 is preferably 655 nm. The PUH 11 also includes a third light source 23 that is a semiconductor laser element, for example. The wavelength of an optical beam emitted from the third light source 23 is preferably 785 nm. The first and second light sources 21 and 22 are provided with λ/2 plates 21a and 22a for adjusting the polarization direction of an emitted laser beam (for changing the ratio of P-polarization to S-polarization to a predetermined ratio), nearby (or as one body).

At a predetermined position of the PUH 11 opposite to the optical disc, an object lens 31 is provided. The object lens condenses the laser beam emitted from one of the first to third light sources 21 to 23 according to the kind of the optical disc D set in the optical disc apparatus 1 shown in FIG. 1, on a not-shown recording surface of the optical disc D, and captures the reflected laser beam reflected on the recording surface. The object lens 31 is a lens applicable to three wavelengths and capable of providing a predetermined numerical aperture (NA) for each laser beam output from the first to second laser elements 21 and 23. The object lens 31 is made of plastic, and has a numerical aperture NA of 0.65 for a laser beam with a wavelength of 405 nm, and 0.6 for a laser beam with a wavelength of 655 nm, for example.

Between the first to third laser elements (light sources) 21 to 23 and the object lens 31, the first optical coupling prism 32, second coupling prism 33, collimator lens 34, and optical diffraction element 35 composed of a polarization dependent diffraction element formed on an optical glass with a predetermined thickness are arranged in this order from the first laser element 21. The optical diffraction element 35 may be formed integrally with a known λ/4 plate(In the following explanation, a λ/4 plate is provided integrally with the optical diffraction element 35 in this example). Usually, in designing an optical path or for decreasing the thickness of the PUH 11, a mirror 36 for bending the optical path (usually called a rising mirror) is provided between the collimator lens 34 and optical diffraction 34 or between the collimator lens 34 and second optical coupling prism 33.

Between the first optical coupling prism 32 and second optical coupling prism 33, a beam splitter 37 is provided. The beam splitter transmits most laser beam traveling from the first optical coupling prism 32 to the second optical coupling prism 33 (namely, from the first light source 21 to the optical disc D), and reflects the reflected laser beam reflected on the recording surface of the optical disc D at a predetermined ratio.

In the traveling direction of the reflected laser beam reflected by the beam splitter 37, a photodetector 41 is provided. The photodetector detects a reflected laser beam reflected on the recording/reproducing surface of the optical disc D, and outputs an electric signal corresponding to the light intensity of the reflected laser beam. The beam splitter 37 is a polarization beam splitter having a plane of polarization set to transmit a P-polarized component and reflect a S-polarized component. In the beam splitter 37, a part of laser beams L1 and L2 from the first and second light sources, that is, a S-polarized component is separated from the laser beam traveling to the optical disc D by being reflected on the plane of polarization. A photodetector 42 for power monitor (APC) (hereinafter called an APC detector) is provided at a predetermined position, so that the beam splitter 37 can detect a laser beam (S-polarized) separated from a laser beam (P-polarized) traveling to the optical disc D. Therefore, the APC detector 42 can be used for either a laser beam with a wavelength of 405 nm (for HD DVD) or laser beam with a wavelength of 655 nm (for DVD).

The first coupling prism (dichroic prism) 32 transmits the laser beam L1 with a wavelength of 405 nm (400 to 410 nm) emitted from the first light source or semiconductor laser element 21 for HD DVD, and reflects the laser beam L2 with a wavelength of 655 nm (640 to 670 nm) emitted from the second light source or the semiconductor laser element 22 for DVD, thereby coupling both laser beams on the same optical path. The first optical coupling prism 32 is demanded to transmit the laser beam L1 from the first light source 21 without substantially decreasing the intensity. Thus, the reflectivity is 0% (except the reflection on the base material surface) for a laser beam with a wavelength shorter than 655 nm, for example. Therefore, a film characteristic inverting wavelength band (wavelength band to invert the characteristics of reflection and transmission) is defined here preferably to 405 to 655 nm. It is known that a wavelength of a laser beam output from a laser element is usually fluctuated by 10 nm/5° C., for example, by fluctuations in the temperature of a laser element and ambient temperature. A central wavelength of an output laser beam is different by individuals. Therefore, actually, a wavelength area of film characteristic inverting wavelength band is of course defined including the influence of the temperature fluctuations.

Contrarily, the second optical coupling prism 33 (trichroic prism) must transmit the laser beams from the first and second light sources 21 and 22 (reflect only the laser beam with a wavelength of 785 nm (775 to 795 nm) from the third light source 23). Therefore, the reflectivity is 0% (except the reflection on the base material surface) for a laser beam with a wavelength shorter than 785 nm, for example. Therefore, a film characteristic inverting wavelength band (wavelength band to invert the characteristics of reflection and transmission) is defined preferably to 655 to 785 nm. Of course, it is known that a wavelength of a laser beam output from a laser element which outputs a laser beam of a wavelength of 785 nm is also fluctuated by 10 nm/5° C., for example, by fluctuations in the temperature of a laser element and ambient temperature. A central wavelength of an output laser beam is different by individuals. Therefore, actually, a wavelength area of film characteristic inverting wavelength band is of course defined including the influence of the temperature fluctuations.

Next, a detailed explanation will be given on radiation of a laser beam from the PUH shown in FIG. 2, and a laser beam from an optical disc.

The laser beam L1 with a wavelength of 405 nm emitted from the first light source 21 is changed in the polarization direction by the λ/2 plate 21a, so that the number of P-polarized components is more than S-polarized components. The laser beam L1 changed in the polarization direction is guided to a rising mirror 36 through the first optical coupling prism 32, beam splitter 37 and second optical coupling prism 33. The rising mirror 36 reflects the laser beam L1 and changes the traveling direction. The laser beam L1 is guided to the object lens 31 through the collimator lens 34 and optical diffraction element (λn/4 plate) 35. The object lens 31 condenses the laser beam L1 on a not-shown recording surface of the optical disc D. The polarization direction of the laser beam L1 after transmitting through the optical diffraction element 35 is circular at a point when it is further rotated by the integrated λ/4 plate and radiated to the optical disc D.

The laser beam L2 with a wavelength of 655 nm emitted from the second light source 22 is changed in the polarization direction by the λ/2 plate 22a, so that the number of P-polarized components is more than S-polarized components. The laser beam L2 changed in the polarization direction is reflected by the first optical coupling prism 32, and guided to the rising mirror 36 along substantially the same optical path as the first laser beam L1, through the beam splitter 37 and second optical coupling prism 33. The laser beam L2 reflected by the rising mirror 36 is converted to a circularly polarized light by the λ/4 plate 35 formed integrally with a diffraction element, and condensed on a not-shown recording surface of the optical disc D by the object lens 31, like the first laser beam L1.

The laser beam L3 with a wavelength of 785 nm emitted from the third light source 23 is reflected by the second optical coupling prism 33, and guided to the rising mirror 36 along substantially the same optical path as the first and second laser beams L1 and L2. The laser beam L3 is reflected by the rising mirror 36, and condensed to a not-shown recording surface of the optical disc D by the object lens 31, like the first and second laser beams L1 and L2.

The S-polarized component of the laser beam is coupled by the first coupling prism 32 and separated from the laser beam traveling to the optical disc D by the beam splitter 37, that is, the laser beam with a wavelength of 405 nm from the first light source 21 and laser beam with a wavelength of 655 nm from the second light source 22, is radiated to the APC detector 42.

The output of the APC detector 42 is used to control the largeness of a laser driving current to be supplied to a laser element outputting that laser beam, by feedback control, though not explained in detail.

The reflected laser beam (R1 to R3) reflected on the recording surface of the optical disc D is captured by the object lens 31 and returned to the optical diffraction element 35. The characteristics of the reflected laser beams R1, R2 and R3 will be explained hereinafter.

The polarization direction of the laser beam R1 with a wavelength of 405 nm is changed from circular to linear in the optical diffraction element 35. The polarization direction of this reflected laser beam R1 is different 90° from the polarization direction of the laser beam L1 traveling to the optical disc D.

The traveling direction of the reflected laser beam R1 changed in the polarization direction is changed by the rising mirror 36, and returned to the polarization beam splitter 37 through the second optical coupling prism 33.

As the polarization direction of the reflected laser beam R1 returned to the polarization beam splitter 37 has been changed 90° from the polarization direction when traveling to the optical disc D, and the laser beam R1 is then reflected by the polarization beam splitter 37 and guided to the photodetector 41.

The reflected laser beam R1 guided to the photodetector 41 is converted to an output signal corresponding to the intensity in the photodetector 41, and processed by a signal processor shown schematically in FIG. 1. Therefore, the information recorded in the optical disc D is reproduced.

The polarization direction of the laser beam R2 with a wavelength of 655 nm is changed from circular to linear in the optical diffraction element 35. The polarization direction of this reflected laser beam R2 is different 90° from the polarization direction of the laser beam L2 traveling to the optical disc D.

The traveling direction of the reflected laser beam R2 changed in the polarization direction is changed by the rising mirror 36, and returned to the polarization beam splitter 37 through the second optical coupling prism 33.

As the polarization direction of the reflected laser beam R2 returned to the polarization beam splitter 37 has been changed 90° from the polarization direction when traveling to the optical disc D, and the laser beam R2 is then reflected by the polarization beam splitter 37 and guided to the photodetector 41.

The reflected laser beam R2 guided to the photodetector 41 is converted to an output signal corresponding to the intensity in the photodetector 41, and processed by a signal processor shown schematically in FIG. 1. Therefore, the information recorded in the optical disc D is reproduced.

Like the laser beams R1 and R2, the laser beam R3 with a wavelength of 785 nm is reflected by the rising mirror 36, and returned to the second optical coupling prism 33. As already explained, the film characteristic inverting wavelength band of the second optical coupling prism 33 is 655 to 785 nm, and the laser beam R3 is reflected to the laser element 23 regardless of the polarization direction of the plane of polarization.

A given reproduce signal of CD can be obtained by adding the third laser element 23 to a laser oscillator, and constructing a photodetector as one body with a detection element.

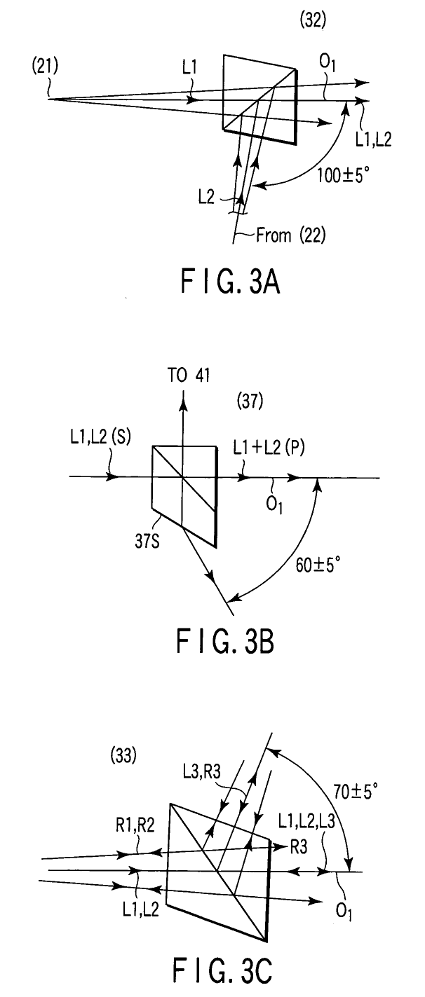

FIGS. 3A to 3C explain the characteristics of an optical coupling prism and a polarization beam splitter incorporated in the PUH (optical pickup) shown in FIG. 2.

FIGS. 3A to 3C shows the characteristics of the optical elements of optical axes (designed optical axes) for a laser beam traveling from the first light source 21 to the object lens 31, that is, optical axes O1 and O2 passing through the first and second optical coupling prisms 32 and 33, polarization beam splitter 37 and object lens 31 (the optical axis O2 is shown for the explanation convenience, and there is only the optical axis O1 in a system without using the rising mirror 36, for example).

As seen from FIG. 3A, in the first optical coupling prism 32, the laser beam L2 with a wavelength of 655 nm from the second light source 22 coupled to the laser beam L1 with a wavelength of 405 nm from the first light source 21 traveling linearly along the optical axis O1 is coupled (synthesized) at an angle of deviation of optical path of 100±5°, for example, to the optical axis O1. Similarly, as seen from FIG. 3C, in the second optical coupling prism 33, the laser beam L3 with a wavelength of 785 nm from the third light source 23 is coupled (synthesized) to the laser beam L1 with a wavelength of 405 nm from the first light source 21 traveling linearly along the optical axis O1 and the synthesized laser beam L2 with a wavelength of 655 nm from the second light source 22, at an angle of deviation of optical path of 70±5°, for example, to the optical axis O1.

The angle of deviation of optical path explained in FIGS. 3A and 3C is set to make the wavelength selection film of each optical coupling prism non-vertical to the optical axis O1, in order to minimize the optical path length difference at the peripheral edge portion (of a divergent beam) distant from an optical axis and the influence of the deviation of transmissivity or reflectivity upon synthesizing (coupling) of two beams, when a divergent laser (divergent beam) traveling along an optical axis enters the wavelength selection film or reflects on the selection film.

Apart from the above, as shown in FIG. 3B, the polarization beam splitter 37 has an exit plane 37S set to an angle to be able to emit the laser beams L1 and L2 for the monitor detector 42, with a component, for example, S-polarized component separated from the laser beams L1 and L2 toward the optical disc D at an angle of deviation of optical path of 65±5° to the optical axis O1 (the polarization beam splitter 37 has an exit plane 37S, which enable radiation of a monitoring laser beam for the APC detector 42 at an angle of deviation of optical path of 60.5° to the optical axis O1). By inclining the light-receiving plane of the APC detector 42 at a predetermined angle to the optical axis O1, the size of the PUH 11 can be decreased compared with the case that the light-receiving plane is defined vertical to the optical axis O1.

Namely, the optical elements (optical coupling prisms 32 and 33) provided between the first to third light sources 21-23 and the object lens 31 in the PUH 11 are preferably set as shown in FIGS. 3A and 3C, in order to obtain a reproduce signal with a high S/N ratio, by making two laser beams with different wavelengths usable in both of the optical detector 41 used to detect a reproduce signal and APC optical detector 42 to monitor the intensities of the laser beams L1 and L2 from the first and second light sources, each can input the laser beams L1-L3 from respective light sources to the object lens 31.

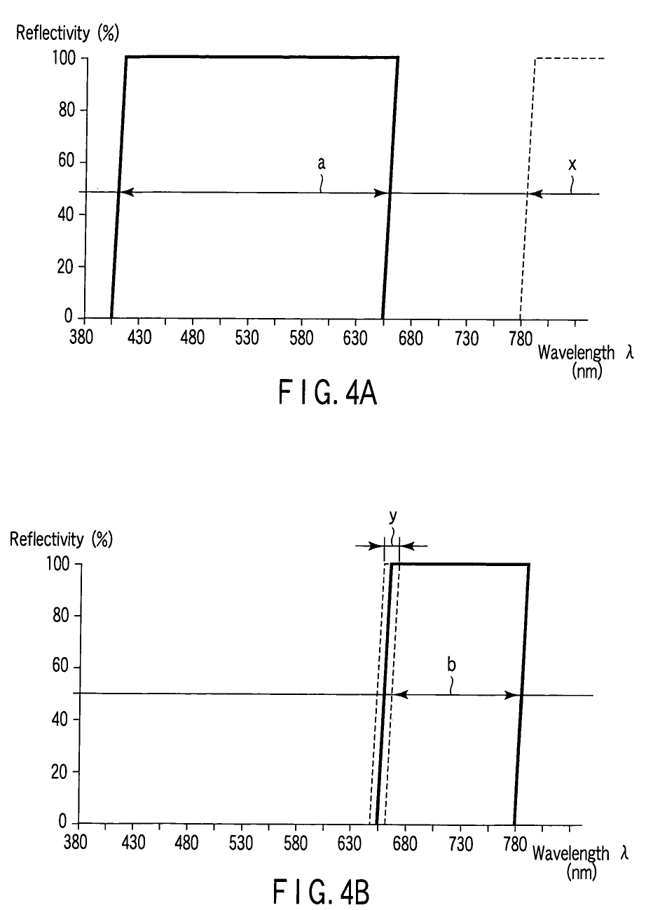

Design and manufacture of the film characteristic inverting wavelength band of the wavelength selection film of the first and second optical coupling prisms become easy as shown in FIGS. 4A and 4B, by coupling the laser beam L1 with a wavelength of 405 nm from the first light source 21 and the laser beam L2 with a wavelength of 655 nm from the second light source 22 by the first optical coupling prism 32 as shown in FIG. 2, as well as arranging the first optical coupling prism 32, polarization beam splitter 37 and second optical coupling prism 33 as shown in FIGS. 3A and 3C.

FIGS. 4A and 4B show a film characteristic inverting characteristic demanded in the film characteristic inverting wavelength band of the first optical coupling prism 32 and second optical coupling prism 33. The film characteristic inverting wavelength band indicated by a band [a] in FIG. 4A is preferably set to 405 to 655 nm as explained with reference to FIGS. 2 and 3. The wavelength characteristic of a film characteristic inverting wavelength band indicated by a band [b] in FIG. 4B is defined to 655 to 785 nm as explained with reference to FIGS. 2 and 3.

Now, for comparing, consider the case of coupling (synthesizing) a laser beam with a wavelength of 405 nm and a laser beam with a wavelength of 785 nm in the first optical coupling prism 32. In this case, the wavelength characteristic of a film characteristic inverting characteristic demanded for a wavelength selection film of the first optical coupling prism 32 is capable of reflecting a laser beam with a wavelength of 785 nm or more, as indicated by a band [x] in FIG. 4A. However, it is necessary to set a wavelength characteristic of a film characteristic inverting characteristic demanded for a wavelength selection film of the second optical coupling prism 33 to very narrow, 640 to 670 nm, as indicated by a band [y] in FIG. 4B.

In other words, as an optical pickup which reproduces information recorded in an optical disc by guiding three laser beams with different wavelengths to an optical disc of optional standard through one optical path and object lens, a reproducing signal of an optical disc using a laser beam with a shortest wavelength or an optical disc using a laser beam with an intermediate wavelength can be obtained with a single photodetector, only by:

placing a light source capable of outputting a laser beam with a longest wavelength in the vicinity of an object lens;

overlaying two laser beams from a light source capable of outputting a laser beam with a shortest wavelength, and a light source capable of outputting a laser beam with an intermediate wavelength, along substantially the same optical path, or an optical path for a laser beam with a longest wavelength; and

separating a laser beam with a longest wavelength out of laser beams reflected by an optical disc, first by a wavelength selection film.

As explained above, by arranging three light sources capable of emitting the first to third wavelength beams of the invention, and providing a wavelength selection film (optical coupling prism) related to the arrangement of these light sources, an optical beam with a wavelength of 405 nm for HD DVD and an optical beam with a wavelength of 655 nm for DVD are coupled by a dichroic mirror, and power monitor (APC) is possible from a component (S-polarized) reflected by a polarization beam splitter, before the both beams reach an optical disc. Further, as an optical beam with a wavelength of 785 nm for CD is synthesized for a component (P-polarized) transmitting through a polarization beam splitter, through a trichroic beam splitter, three beams with different wavelengths can be radiated to an optical disc along the same optical path. Therefore, an object lens can be only the one applicable to three wavelengths.

On the other hand, among the reflected optical beams reflected by an optical disc, an optical beam with a wavelength of 785 nm for CD is separated from an optical beam for HD DVD or DVD, by a trichroic beam splitter. Therefore, an optical beam for CD does not enter a photodetector which detects an optical beam for HD DVD or DVD, and as a result a reproducing signal from HD DVD or DVD can be reproduced stably with a high S/N ratio by the same photodetector.

As explained hereinbefore, according to an embodiment of the invention, there is provided an optical pickup (optical head unit) which can condense optical beams with predetermined wavelengths from light sources capable of outputting optical beams with different wavelengths, to recording media with different recording densities capable of recording and reproducing information by using optical beams with different wavelengths, through a single optical path and object lens; and can use both photodetector and power monitor (APC), having high compatibility to recording media. Therefore, there is provided an optical head unit and an information recording/reproducing apparatus, which can record and reproduce information regardless of the standards of optical discs. This decreases the weight and cost of the apparatus. A mechanical vibration is prevented by reducing the weight and size. As a result, stable continuous operation is possible, and reliability is increased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head unit comprising:
an object lens which captures light reflected on the recording/reproducing surface of a recording medium;
a first optical element which reflects light from a light source to emit an optical beam with a longest wavelength, in a direction to a light source and in a direction from a light source to a recording medium, respectively, on an optical path toward the object lens;
a second optical element which transmits light from a light source to emit an optical beam with a shortest wavelength, and light with an intermediate wavelength between a light from a light source to emit an optical beam with a shortest wavelength and light from a light source to emit an optical beam with a longest wavelength, in a direction to a recording medium, and reflects in a direction reflected by a recording medium, at a predetermined position farther from the object lens than the first optical element, on an optical path toward the object lens; and
a third optical element which transmits light from a light source to emit an optical beam with a shortest wavelength, in a direction to a recording medium, and reflects light with an intermediate wavelength between light from a light source to emit an optical beam with a shortest wavelength and light from a light source to emit an optical beam with a longest wavelength, in a direction to a recording medium, at a predetermined position farther from the object lens than the second optical element, on an optical path toward the object lens.

2. The optical head unit according to claim 1, wherein the third optical element has an reflection film with a wavelength band of 405 to 655 nm of a film characteristic inverting wavelength band.

3. The optical head unit according to claim 1, wherein the first optical element has an reflection film with a wavelength band of 655 to 785 nm of a film characteristic inverting wavelength band.

4. The optical head unit according to claim 3, wherein the third optical element has a reflection film with a wavelength band of 405 to 655 nm of a film characteristic inverting wavelength band.

5. The optical head unit according to claim 2, wherein the first optical element has a reflection film with a wavelength band of 655 to 785 nm of a film characteristic inverting wavelength band.

6. An optical head unit comprising:
a first light source which outputs light with a shortest wavelength;
a second light source which outputs light with a second wavelength longer than the wavelength of the light from the first light source;
a third light source which outputs light with a third wavelength longer than both lights from the first and second light sources;
a first optical coupling prism which transmits the light from the first light source, between the first light source and second light source, reflects the light from the second light source, and synthesizes these light;
a second optical coupling prism which transmits the light synthesized by the first optical coupling prism, reflects the light from the third light source, and synthesizes these lights;
an object lens applicable to three wavelengths, which condenses the light synthesized by the second optical coupling prism on a recording surface of a recording medium, and captures a reflected light reflected by a recording medium; and
a beam splitter which transmits (reflects) at least a part of the light synthesized by the first optical coupling prism, between the first and second optical coupling prisms, and reflects light reflected by a recording medium.

7. The optical head unit according to claim 6, further comprising a photodetector which is provided at a predetermined position in the direction that the beam splitter reflects the light reflected by a recording medium, and generates an output signal corresponding to the intensity of the reflected light.

8. The optical head unit according to claim 6, further comprising a monitor photodetector which detects at least a part of the light synthesized by the first optical coupling prism reflected by the beam splitter, and generates an output signal corresponding to the intensity of the light.

9. An information recording/reproducing apparatus comprising:
an optical head unit; and
a signal reproduce circuit which takes out a signal component corresponding to information from a signal detected by the photodetector, to reproduce the information recorded in a recording medium.

10. The information recording/reproducing apparatus according to claim 9, further comprising a photodetector which is provide at a predetermined position in the direction that the beam splitter reflects the light reflected by a recording medium, and generates an output signal corresponding to the intensity of the reflected light.

11. The information recording/reproducing apparatus according to claim 9, further comprising a monitor photodetector which detects at least a part of the light synthesized by the first optical coupling prism reflected by the beam splitter, and generates an output signal corresponding to the intensity of the light.
